(19) United States
(12) Patent Application Publication
(10) Pub. No.: US 2025/0111593 A1
(43) Pub. Date: Apr. 3, 2025

(54) INFORMATION PROCESSING APPARATUS PROCESSING THREE DIMENSIONAL MODEL, METHOD FOR CONTROLLING THE SAME, AND STORAGE MEDIUM

(71) Applicant: CANON KABUSHIKI KAISHA, Tokyo (JP)

(72) Inventor: SHINGO MORI, Kanagawa (JP)

(21) Appl. No.: 18/903,899

(22) Filed: Oct. 1, 2024

(30) Foreign Application Priority Data
Oct. 3, 2023 (JP) 2023-171954

(51) Int. Cl. G06T 15/20

(52) U.S. Cl. CPC G06T 15/20; G06T 2200/24

(57) ABSTRACT

Some embodiments are directed to reduction of time and effort to view a plurality of 2.5 dimensional (D) models while maintaining visibility. An information processing apparatus includes one or more memories storing instructions and one or more processors. The one or more processors are in communication with the one or more memories and, when executing the instructions, cooperate with the one or more memories to acquire a plurality of three-dimensional (3D) models each corresponding to a first object and viewing the first object from different viewpoint positions, specify a position and an orientation of a viewpoint for viewing a 3D model, select at least one 3D model from among the plurality of 3D models based on the position and orientation of the viewpoint, and generate an image of the at least one 3D model viewed from the position and orientation of the viewpoint.

### BACKGROUND

### Field of the Disclosure

The present disclosure relates to an information processing apparatus that processes a three-dimensional (3D) model, a method for controlling the same, and a storage medium.

### Description of the Related Art

A three-dimensional (3D) model generated based on information acquired by capturing an image of an object using a red-green-blue-depth (RGBD) camera (RGB sensor+depth sensor) such as a stereo camera includes 3D information of the object in an imaging direction but lacks 3D information from behind the object. In the present specification, such a 3D model is referred to as a 2.5D model. As a method for viewing a 2.5D model, a 2.5D model is opened using a viewer application that can view a 3D model and is viewed by moving a virtual camera provided in the viewer in the same way as viewing a general 3D model. Since a 2.5D model only has 3D information from a direction in which it is captured, if a user wants to view a 3D model of an object from various directions including from behind, the user needs to acquire 3D information from various directions and generate a plurality of 2.5D models. At this time, it is time-consuming to open and view the 2.5D model one by one in the viewer application.

Further, in a case where all 2.5D models are opened and viewed in the viewer, there is a risk that visibility of the object is impaired. A position and an orientation of a 2.5D model usually include errors. In such a case, boundaries between the 2.5D models do not match and incompletely overlap, so that the visibility of the object is deteriorated.

According to Japanese Unexamined Patent Application Publication No. 2020-525927, a method for guiding a user's viewpoint to a direction away from an area of an incomplete 3D model including a back of a 2.5D model to divert a user's attention from the area is discussed. However, in the above-described case, a good-looking area and a bad-looking area are mixed in the same field of view, so that it is difficult to improve visibility by guiding the viewpoint.

### SUMMARY

Embodiments of the present disclosure are directed to reduction of time and effort to view a plurality of 2.5D models while maintaining visibility to solve the above-described issue.

According to an aspect of the present disclosure, an information processing apparatus includes one or more memories storing instructions and one or more processors. The one or more processors are in communication with the one or more memories and, when executing the instructions, cooperate with the one or more memories to acquire a plurality of three-dimensional (3D) models each corresponding to a first object and viewing the first object from different viewpoint positions, specify a position and an orientation of a viewpoint for viewing a 3D model, select at least one 3D model from among the plurality of 3D models based on the position and orientation of the viewpoint, and generate an image of the at least one 3D model viewed from the position and orientation of the viewpoint.

Further features of various embodiments will become apparent from the following description of exemplary embodiments with reference to the attached drawings.

### BRIEF DESCRIPTION OF THE DRAWINGS

FIG. 1 illustrates a hardware configuration of an information processing apparatus according to an exemplary embodiment and a modification of the present disclosure.

FIG. 2 is a flowchart for displaying a 2.5 dimensional (D) model according to a first exemplary embodiment.

FIGS. 3A and 3B illustrate a head of an object (person).

FIGS. 4A and 4B illustrate 2.5D models.

FIG. 5 is an image diagram illustrating each model arranged in a three-dimensional (3D) space according to the first exemplary embodiment.

FIGS. 6A and 6B illustrate a viewpoint position and a 2.5D model to be selected according to the first exemplary embodiment.

FIGS. 7A and 7B illustrate another viewpoint position and a 2.5D model to be selected according to the first exemplary embodiment.

FIGS. 8A and 8B illustrate yet another viewpoint position and a 2.5D model to be selected according to the first exemplary embodiment.

FIGS. 9A and 9B illustrate a restricted range of a viewpoint position according to the first exemplary embodiment.

FIGS. 10A and 10B illustrate movable ranges of a viewpoint in each of two 2.5D models.

FIG. 11 is a graph illustrating a relationship between position and orientation of a viewpoint and reliability of a field of view according to the first exemplary embodiment.

FIGS. 12A and 12B are flowchart and a diagram for displaying a 2.5D model according to a second exemplary embodiment.

FIGS. 13A and 13B illustrate 3D primitives and a viewpoint route according to the second exemplary embodiment.

FIG. 14 is a flowchart for displaying a 2.5D model according to a third exemplary embodiment.

### DESCRIPTION OF THE EMBODIMENTS

Exemplary embodiments will be described in detail below with reference to the attached drawings. The following exemplary embodiments are not meant to limit the scope of every embodiment as encompassed by the appended claims. A plurality of features is described in the exemplary embodiments, but not all of these features are essential to every embodiment, and the plurality of features may be arbitrarily combined. Further, the same or similar components in the attached drawings are denoted by the same reference numerals, and redundant description will be omitted.

According to the present exemplary embodiment, a 2.5 dimensional (D) model refers to a three-dimensional (3D) model that is acquired by integrating color of an object viewed from a certain viewpoint and a distance from the viewpoint to the object that corresponds to the color or a video or a plurality of images that is generated using the 3D model.

A first exemplary embodiment described below is an example of an apparatus that executes a 2.5D model processing method by a computer. According to the present exemplary embodiment, a 3D model of an object (for example, a head of a person) that is acquired by capturing images of the object from a plurality of directions, but lacks information from some directions, is referred to as a 2.5D model. According to the present exemplary embodiment, a use case in which a user views an object from various directions using a plurality of 2.5D models is described. The present exemplary embodiment can be executed on a desktop computer, a laptop computer, a portable computer, and the like.

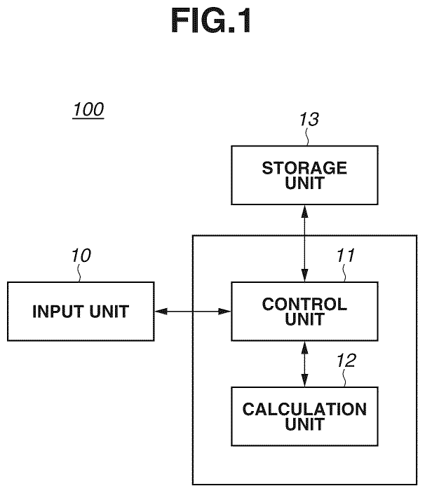

A configuration of an information processing apparatus 100 that executes a 2.5D model processing method is described with reference to FIG. 1. FIG. 1 is a block diagram illustrating a minimum functional configuration for executing processing of the present disclosure, and other components are not illustrated.

An input unit 10 in FIG. 1 is an interface, such as a mouse, a keyboard, or a joystick, that receives an action from a user and acquires information necessary for 2.5D model processing. The information necessary for 2.5D model processing is information about a plurality of 2.5D models and positions and orientations of viewpoints. In other words, the input unit 10 includes a model acquisition unit and a viewpoint position and orientation acquisition unit. Here, the viewpoint is a standpoint for viewing a 2.5D model placed in a 3D space and has parameters such as a position, an orientation, an angle of view, and resolution, similar to a virtual camera in a 3D model viewer application. According to the present exemplary embodiment, in addition to the above-described information, information about the position and orientation of the 2.5D model is acquired from the input unit 10 (the input unit 10 includes a 2.5D model position and orientation acquisition unit).

A control unit 11 controls data of the input unit 10, a calculation unit 12, and a storage unit 13 as well as each unit in the entire information processing apparatus 100. The control unit 11 has a function of acquiring an image at the above-described viewpoint and a function of selecting an appropriate 2.5D model from the plurality of 2.5D models.

The calculation unit 12 includes a calculation processing device and executes a calculation processing program stored in the storage unit 13.

The storage unit 13 is configured with primary storage devices such as a memory (e.g., a random access memory (RAM)) and secondary storage devices such as a solid state drive (SSD) and a hard disk. The storage unit 13 stores the 2.5D models, information about positions and orientations thereof, information about the position and orientation of the viewpoint, and the like input via the input unit 10. The storage unit 13 also stores information about processing of the 2.5D model processed by the calculation unit 12.

The control unit 11 includes a built-in central processing unit (CPU) as a computer and controls each unit in the entire information processing apparatus 100 via a bus based on a computer program stored in a non-volatile memory.

### <<2.5D Model Processing Method>>

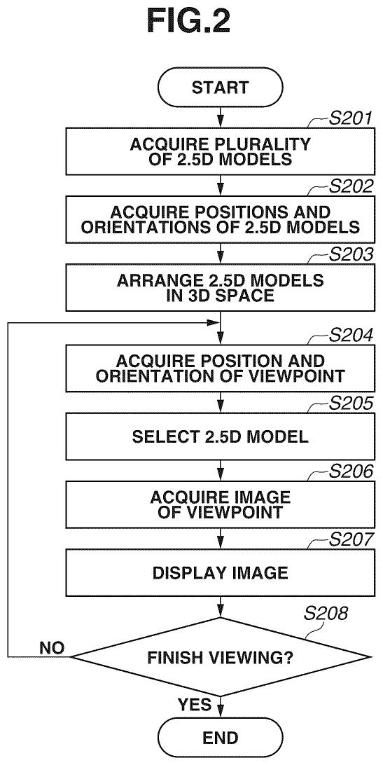

The 2.5D model processing method to be executed in the information processing apparatus 100 according to the present exemplary embodiment is specifically described with reference to a flowchart in FIG. 2. Processing corresponding to each step in the flowchart is realized in such a way that, for example, the control unit 11 reads out a corresponding processing program stored in a nonvolatile memory in the storage unit 13, loads it to a volatile memory in the control unit 11, and executes it to cause each unit to operate.

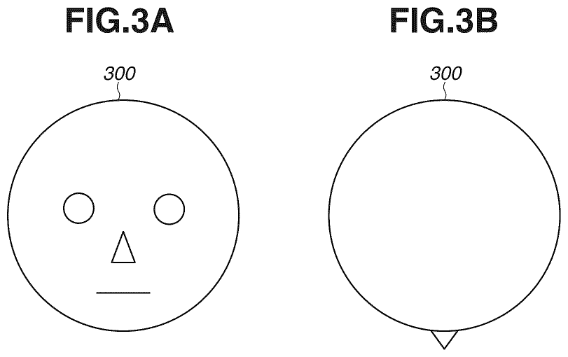

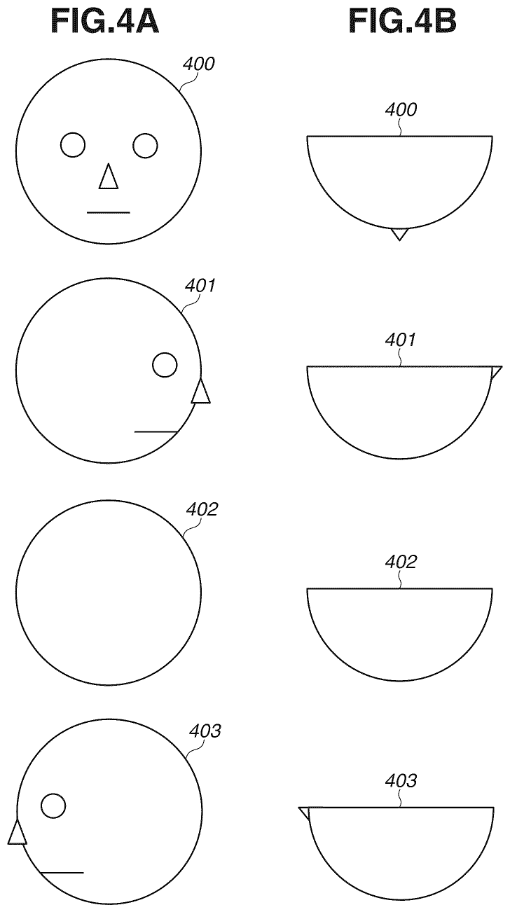

In step S201, the control unit 11 acquires a plurality of 2.5D models via the input unit 10 and stores them in the storage unit 13. According to the present exemplary embodiment, data of the plurality of 2.5D model are acquired from a head 300 of a person in FIGS. 3A and 3B. FIGS. 3A and 3B illustrate the head 300 of the person viewed from the front and from above, respectively. The calculation unit 12 generates 2.5D models of the head 300 from four directions, the front, left, right, and back, and the control unit 11 acquires them via the input unit 10. FIG. 4A illustrates a state in which 2.5D models 400, 401, 402, and 403 each indicating a 2.5D model acquired from each direction is viewed from the acquired direction. FIG. 4B illustrates a state in which each of the 2.5D models 400, 401, 402, and 403 in FIG. 4A is viewed from above. Since the 2.5D model only includes information about an imaging direction, these 2.5D models lack information about the head in an opposite direction.

In step S202, the control unit 11 acquires positions and orientations of the plurality of 2.5D models acquired in step S201 via the input unit 10 and stores them in the storage unit 13.

In step S203, the control unit 11 arranges the plurality of 2.5D models in the 3D space based on the positions and orientations acquired in step S202.

In step S204, the control unit 11 acquires the position and orientation of the viewpoint via the input unit 10 and stores them in the storage unit 13. According to the present exemplary embodiment, if the processing in step S204 is executed for the first time, the position and orientation of the viewpoint facing a face of the head 300 are acquired from a position in front of the head 300 of the person. Here, a viewpoint direction has a meaning similar to an imaging direction of the virtual camera in the viewer application and is a direction from the standpoint of the viewpoint toward the object. The viewpoint direction is uniquely determined based on the orientation of the viewpoint. In a case where the processing in step S207 is executed and then the processing in step S204 is executed again, the position and orientation of the viewpoint are acquired in response to a user input.

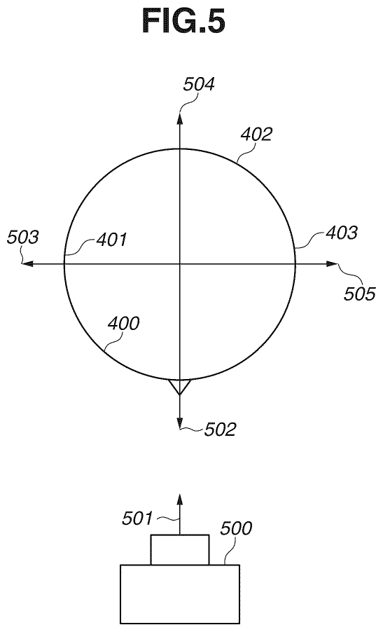

FIG. 5 illustrates a 3D space reflecting the information from steps S202 to S204. The 2.5D models 400, 401, 402, and 403 are arranged to partially overlap each other. A viewpoint 500 (illustrated as a virtual camera in the sense of the imaging direction) is placed in front of the 2.5D model 400 to face the direction of the 2.5D model 400 as illustrated in FIG. 5. An arrow 501 indicates a direction of the viewpoint 500.

In step S205, the control unit 11 selects a specific 2.5D model from among the plurality of 2.5D models existing in a field of view based on the position and orientation of the viewpoint. According to the present exemplary embodiment, as indicated in expression (1), the 2.5D model with a smallest cosine between the imaging direction of each 2.5D model and the viewpoint direction is selected. The imaging direction of the 2.5D model is acquired from a coordinate system defined in the 2.5D model. The imaging directions of the 2.5D models 400, 401, 402, and 403, are indicated by arrows 502, 503, 504, and 505, respectively. In expression (1), dᵥ is a direction vector of the viewpoint, dₘ is an imaging direction vector of a 2.5D model m, and · represents an inner product.

$$arg {min}_{m} ( {d}_{v} \cdot {d}_{m} ) \qquad ( 1 )$$

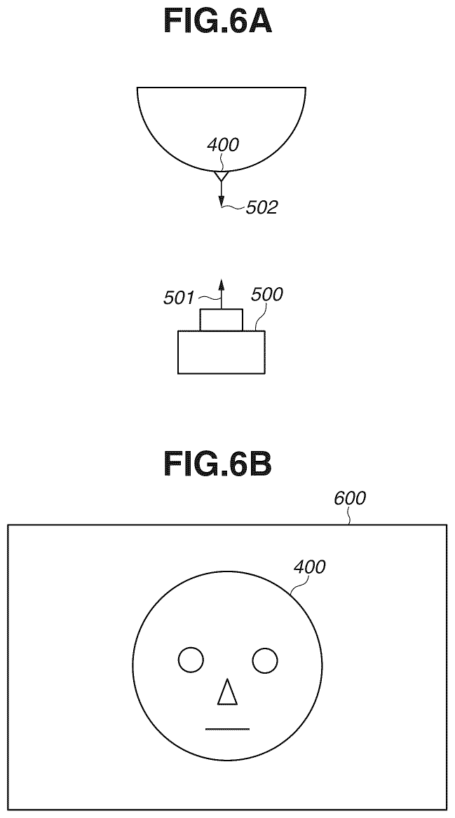

FIGS. 6A and 6B illustrate a viewpoint position and a 2.5D model to be selected. In other words, if the viewpoint 500 is in the position and orientation as illustrated in FIG. 6A, the 2.5D model 400 that almost directly faces it is selected. In FIG. 6A, the 2.5D models 401, 402, and 403, which are not selected, are not illustrated.

In step S206, the control unit 11 acquires an image from the viewpoint. The image referred to here is an image that depicts the 3D space in which the 2.5D model acquired based on the parameters of the viewpoint is arranged. However, only the specific 2.5D model selected in step S205 from among the plurality of 2.5D models is displayed in the image. An image 600 in FIG. 6B is the image. Since the 2.5D model 400 is currently selected, only the 2.5D model 400 is displayed in the image 600.

In step S207, the control unit 11 displays the image 600 acquired in step S206 on an image display unit, which is not illustrated in FIG. 1.

In step S208, the user determines whether to finish viewing the image. If viewing is finished (YES in step S208), the control unit 11 terminates the display of the image. If viewing is not finished (NO in step S208), the processing proceeds to step S204.

In step S204, the control unit 11 acquires the position and orientation of the viewpoint again via the input unit 10.

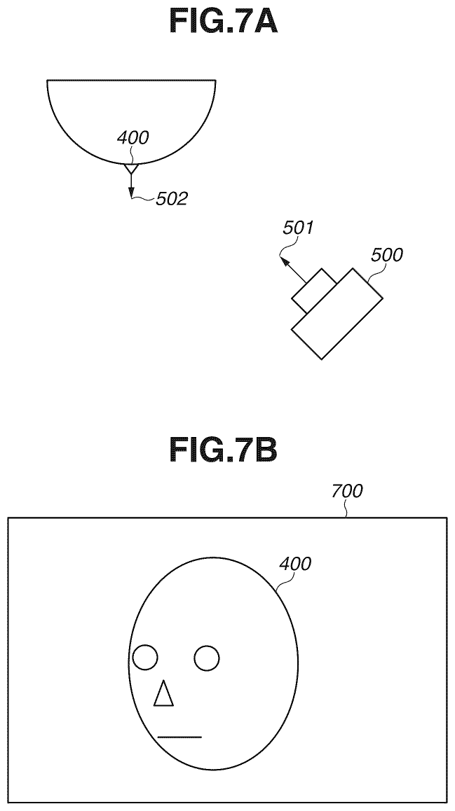

In step S205, the control unit 11 selects the 2.5D model again. FIGS. 7A and 7B illustrate a viewpoint position and a 2.5D model to be selected different from those in FIGS. 6A and 6B. FIG. 7A illustrates the viewpoint and a 3D space in which the selected 2.5D model is arranged. The position and orientation of the viewpoint are changed, but the 2.5D model selected based on expression (1) remains the 2.5D model 400.

In steps S206 and S207, the image acquired at the viewpoint 500 is displayed on the image display unit. An image 700 in FIG. 7B is the image. The position and orientation of the viewpoint are changed, so that the displayed image 700 is different from the image 600.

A situation where the position and orientation of the viewpoint are acquired again is described below. Descriptions similar to those above will be omitted.

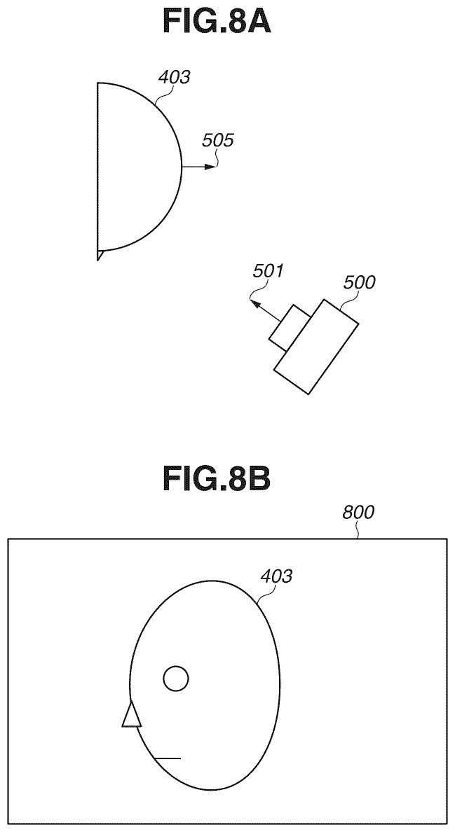

FIGS. 8A and 8B illustrate a viewpoint position and a 2.5D model to be selected further different from those in FIGS. 6A and 6B and FIGS. 7A and 7B. FIG. 8A illustrates a viewpoint reflecting newly acquired position and orientation and a 3D space in which a selected 2.5D model is arranged. The 2.5D model 403 is selected according to expression (1). An image 800 in FIG. 8B is an image acquired at the viewpoint 500 at this time. Only the 2.5D model 403 is displayed, and the other 2.5D models 400, 401, and 402 are not displayed.

The method for allowing a user to view the 2.5D model by controlling (specifying) the position and orientation of the viewpoint in a case where there is a plurality of 2.5D models of the head is described above. Since the displayed 2.5D model is switched corresponding to the specified position and orientation of the viewpoint, it is possible to eliminate time and effort to open files of the plurality of 2.5D models one by one. The position and orientation of the 2.5D model usually include errors. In such a case, boundaries between the 2.5D models do not match and overlap incompletely, resulting in poor visibility of the object. To address this issue, an appropriate 2.5D model is selected according to the viewpoint, and only the selected 2.5D model is displayed, so that incomplete overlap is not generated, and visibility of the object can be maintained. On the other hand, in order to more accurately display an image corresponding to the specified position and orientation of the viewpoint, a plurality of 2.5D models may be combined to generate a 2.5D model corresponding to the position and orientation of the viewpoint.

In a case where the selected 2.5D model is changed, the position and orientation of the viewpoint may be adjusted so that a size of the 2.5D model appearing in images successively displayed is constant (the same). Specifically, the position and orientation of the viewpoint are adjusted so that the size of the same object successively displayed in the images matches with each other. Existing methods such as block matching and machine learning may be used to detect the same object. Also, shape information of the 2.5D model may be used for matching, and the position and orientation of the viewpoint may be adjusted so that a contour or a silhouette of the 2.5D model is constant. Performing an operation as described above reduces a feeling of strangeness felt by a user at a time of switching the 2.5D models. This effect can be similarly achieved not only in a case of adjusting the viewpoint, but also in a case of adjusting the position and orientation or the size of the 2.5D model at the time of changing the 2.5D model.

According to the present exemplary embodiment, the position and orientation of the viewpoint are acquired from a user input and can be arbitrarily set, but the position and orientation of the viewpoint may be restricted so as not to move far away from the imaging direction of the 2.5D model. Specifically, first, the orientation is restricted so that an angle between the viewpoint direction and the imaging direction is within a certain range to satisfy equation (2). In equation (2), t is a threshold value, and as it is smaller, the viewpoint direction is more restricted from moving away from the imaging direction.

dᵥ·dₘ<t (2)

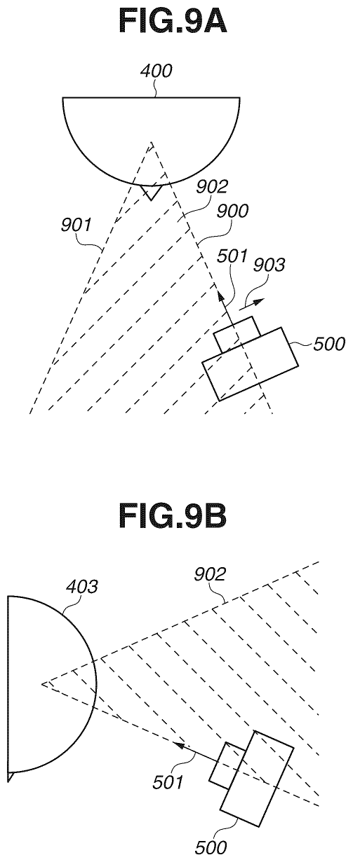

Next, a restriction on the position is described. FIG. 9A illustrates a restricted range of the position of the viewpoint. Half lines 900 and 901 in FIG. 9A extend from the center of the 2.5D model 400 and have the same gradient as dᵥ that satisfies equation (3). A dashed line area 902 represents an area bounded by the half lines 900 and 901, and the position of the viewpoint is restricted to this area.

dᵥ·dₘ=t (3)

An effect of a distance error of the 2.5D model on an appearance thereof increases as the viewpoint direction moves away from the imaging direction. If the position and orientation of the viewpoint are restricted as in equation (2) and the dashed line area 902, a bad looking image is unlikely to be acquired, so that the visibility of the object is likely to be maintained.

If the position and orientation of the viewpoint are instructed to be changed in a way they exceed the restriction in a state where they are restricted as described above, the control unit 11 may select the 2.5D model depending on a moving direction of the viewpoint. FIG. 9A illustrates a state where the viewpoint 500 just before exceeding the restriction and the 3D space in which the selected 2.5D model 400 is arranged is viewed from above. Here, the dashed line area 902 indicates a moving range of the viewpoint 500, and an arrow 903 indicates the moving direction of the viewpoint 500. FIG. 9B illustrates a state where the 3D space in which the 2.5D model 403 is newly selected according to the moving direction of the viewpoint is viewed from above. Here, the 2.5D model 403 is selected because it is located in a direction of the moving direction 903 of the viewpoint 500 from the 2.5D model 400. As with the 2.5D model 400, restrictions on the orientation and the moving range of the viewpoint are set to the 2.5D model 403. The dashed line area 902 indicates the moving range of the viewpoint 500. The viewpoint 500 is moved so as not to exceed the restriction on the moving range set on the selected 2.5D model 403, and the orientation is also changed to face substantially in the imaging direction of the 2.5D model 403.

The method for selecting the 2.5D model according to the moving direction of the viewpoint if the position and orientation of the viewpoint are restricted is described above. Since the viewpoint direction is unlikely to move away from the imaging direction of each 2.5D model, it is possible to view a plurality of 2.5D models by operating the viewpoint based on a user input while maintaining the visibility of each 2.5D model.

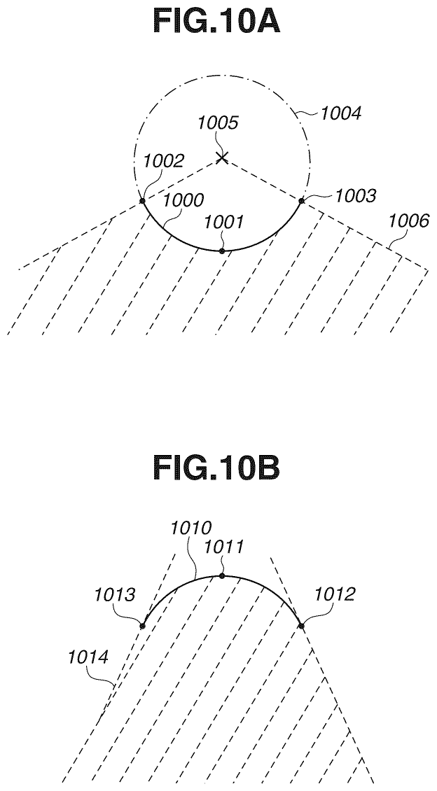

The restricted range of the position and orientation of the viewpoint may be determined for each selected 2.5D model. FIGS. 10A and 10B illustrate respective movable ranges of the viewpoints in two 2.5D models. FIG. 10A illustrates a 2.5D model 1000 that is convex with respect to the viewpoint, and FIG. 10B illustrates a 2.5D model 1010 that is concave with respect to the viewpoint.

Whether the 2.5D model is convex or concave is determined, for example, as follows. Intersection points of straight lines passing through the centers of the 2.5D models and extending in the imaging direction with the 2.5D models 1000 and 1010 are respectively designated as points 1001 and 1011. The centers of the 2.5D models 1000 and 1010 are compared with positions of the points 1001 and 1011, respectively. If the point is in front of the center (lower side of the page in FIGS. 10A and 10B), it can be determined as convex, and vice versa, it can be determined as concave.

FIG. 10A illustrates a state where the movable range of the viewpoint in the 2.5D model 1000 that is convex with respect to the viewpoint is viewed from above. Points 1002 and 1003 indicate end points of the 2.5D model 1000 that exist on the same surface as the point 1001. An alternate long and short dash line indicates a circle 1004 passing through the points 1001, 1002, and 1003, and a point 1005 indicates the center of the circle 1004.

An area bounded by half lines extending from the center 1005 of the circle 1004 to the points 1002 and 1003 is a dashed line area 1006. This is the movable range of the viewpoint. The dashed line area 1006 is defined by a plane passing through the points 1002, 1003, and 1005, but the movable range of the position of the viewpoint can be set in the 3D space by setting a plane passing through the point 1005 and other end points of the 2.5D model using a similar method. The range of the orientation may be restricted, for example, to face approximately the point 1005.

FIG. 10B illustrates a state where the movable range of the viewpoint in the 2.5D model 1010 that is concave with respect to the viewpoint is viewed from above. Points 1012 and 1013 indicate end points of the 2.5D model 1010 that exist on the same surface as the point 1011. A gradient is calculated by differentiation using information around the points 1012 and 1013, and a tangent line at each point is calculated. A dashed line area 1014 inside each tangent line is the movable range of the viewpoint. Similar to FIG. 10A, the movable range of the position of the viewpoint in the 3D space can be acquired by setting tangent lines at other end points.

The method for setting the range of the position and orientation of the viewpoint for each 2.5D model is described above. The range of the position and orientation of the viewpoint are appropriately set for each 2.5D model, so that the object can be viewed from various viewpoints while maintaining the visibility of the object. In a case of the convex 2.5D model, if the range of the position is determined using a similar method to the concave 2.5D model, the viewpoint direction can move far away from the imaging direction of the 2.5D model. This issue can be avoided by assuming the circle 1004 along a surface of the convex 2.5D model as described above and setting the restricted range based on the center 1005. Conversely, if the concave 2.5D model is restricted using a similar method to the convex 2.5D model, the moving range on the front side (the lower side of the page) is narrowed, so that the visibility of the object can be improved by separating the processing for the concave 2.5D model and the convex 2.5D model.

At this time, a position, an orientation, and a size of a background model around a plurality of 2.5D models may be adjusted so that a background displayed in the field of view does not significantly change—in other words, a change in the background is within a predetermined range. The background model refers to a 3D model arranged around the plurality of 2.5D models or a 3D model arranged to surround the 2.5D models. The latter includes a sphere, a cube, and a hemisphere for image-based lighting. Since the background within the field of view does not move significantly, a user can view the 2.5D model without significantly losing the sense of continuity of viewing the same object.

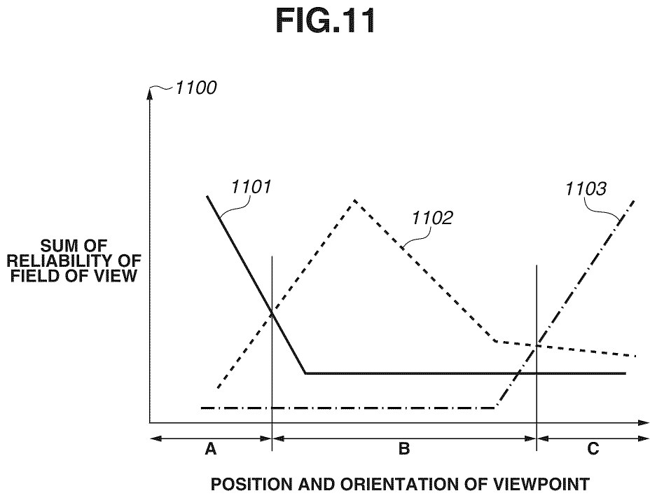

In addition, the 2.5D model may be selected based on the position and orientation of the viewpoint and reliability associated with the 2.5D model. The reliability is a value indicating how reliable the shape information of the 2.5D model is. For example, a stereo camera acquires shape information using the block matching method, and a correlation value acquired at that time may be used as the reliability. The reliability is calculated for each area of the 2.5D model, so that the 2.5D model with the largest sum of reliability in the field of view may be selected. A graph 1100 in FIG. 11 illustrates a relationship between the position and orientation of the viewpoint and reliability of the field of view. The graph 1100 indicates reliability 1101, 1102, and 1103 of three 2.5D models. The 2.5D model with the reliability 1101, the 2.5D model with the reliability 1102, and the 2.5D model with the reliability 1103 are respectively selected in areas A, B, and C.

Also, an average value of the reliability of each area may be defined as the reliability of the 2.5D model, and the average values may be compared to select the 2.5D model with the highest reliability. The former has an advantage that the 2.5D model can be selected by taking into consideration the number of 2.5D models captured in the field of view, and the latter has an advantage of requiring a small amount of calculation and being compatible with real-time processing. The 2.5D model is selected based on the reliability, so that if there is a plurality of similar 2.5D models captured in continuous imaging, the 2.5D model with the best shape can be automatically selected.

A second exemplary embodiment described below is an example of an apparatus that executes a 2.5D model processing method by a computer. According to the present exemplary embodiment, a use case in which a moving image is generated using a 2.5D model of a head of a person acquired from a plurality of angles is described. According to the present exemplary embodiment, a 2.5D model refers to a 3D model. Descriptions of configurations and processing similar to those according to the first exemplary embodiment are omitted. Some embodiments can be executed on a desktop computer, a laptop computer, a portable computer, and the like.

The 2.5D model processing method according to the present exemplary embodiment is described below, but a configuration of a computer that executes the present processing method is similar to that according to the first exemplary embodiment, so that the description thereof is omitted.

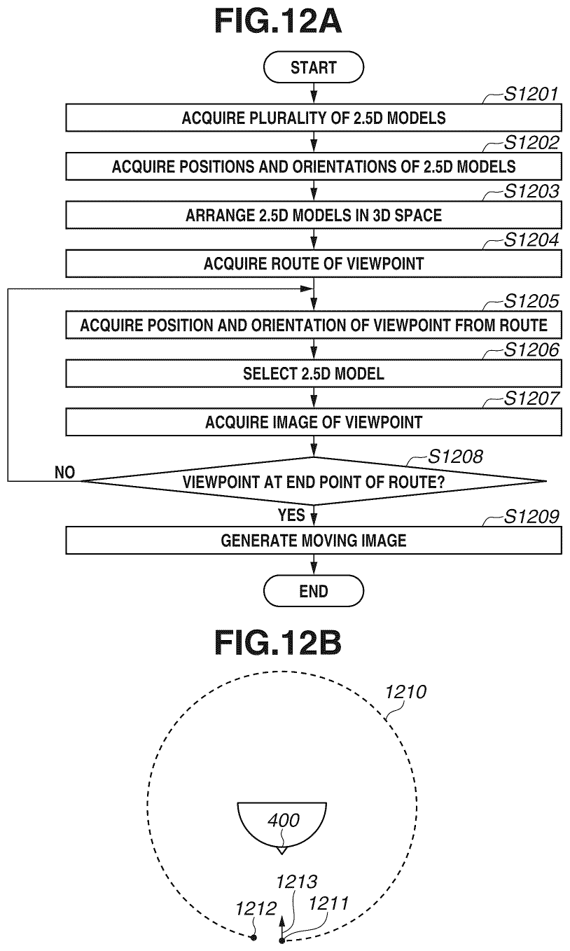

The 2.5D model processing method executed by the computer according to the present exemplary embodiment is specifically described with reference to a flowchart in FIG. 12A and FIG. 12B. However, steps S1201 to S1203 are similar to those according to the first exemplary embodiment, so that the descriptions thereof are omitted.

In step S1204, the control unit 11 acquires a route of the viewpoint and stores it in the storage unit 13. Here, the route is information representing the positions and orientations of a plurality of viewpoints in a set order. As illustrated in FIG. 12B, an acquired route 1210 is set to surround the head 300.

In step S1205, the control unit 11 acquires the position and orientation of a first viewpoint 1211 from the acquired route 1210. The position of the viewpoint 1211 is in front of the 2.5D model 400, and the orientation is set to face a direction of an arrow 1213. In a case where the processing in step S1205 is executed again after the processing in step S1208 is executed, the position and orientation of the viewpoint next to the viewpoint previously subjected to the processing is acquired.

In step S1206, the control unit 11 selects the 2.5D model based on the position and orientation of the viewpoint. A selecting method is similar to that according to the first exemplary embodiment, so that the description thereof is omitted. In FIG. 12B, only the 2.5D model 400 selected at the first viewpoint 1211 is illustrated.

In step S1207, the control unit 11 acquires an image at the viewpoint acquired in step S1205 and stores it in the storage unit 13. Here, the 2.5D model selected in step S1206 is displayed in the image as in the first exemplary embodiment.

In step S1208, the control unit 11 determines whether the position and orientation of the current viewpoint is at an end point 1212 of the route 1210. If the viewpoint is not at the end point 1212 of the route 1210 (NO in step S1208), the control unit 11 executes the processing in step S1205 again. If the viewpoint reaches the end point 1212 of the route 1210 (YES in step S1208), the control unit 11 executes the processing in step S1209.

In step S1209, the control unit 11 generates a moving image based on a plurality of images stored in the storage unit 13 and stores the moving image in the storage unit 13. The method for generating a video in which an appropriate 2.5D model is displayed according to the position and orientation of the viewpoint in a case where a plurality of 2.5D models of a head and a route of the viewpoint are given is described above. Since the 2.5D model to be displayed is switched according to the position and orientation of the viewpoint, there is no need to take time and effort to select the 2.5D model appearing in each frame of the moving image one by one from the plurality thereof. As in the first exemplary embodiment, an appropriate 2.5D model is selected according to the viewpoint, and only the selected 2.5D model is displayed in a frame of the moving image, so that incomplete overlap is not generated between the 2.5D models, and visibility of the object can be maintained.

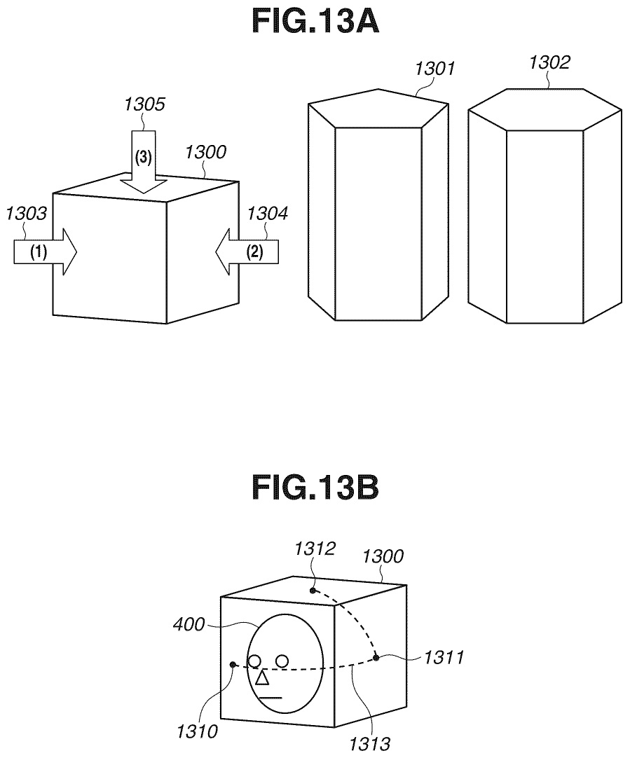

According to the present exemplary embodiment, a method for generating a route is not particularly specified, but an order in which surfaces of a 3D primitive are specified by a user input may be acquired, and the route may be generated based on the order. The 3D primitive refers to a 3D figure of which surfaces can be specified, such as a rectangular parallelepiped 1300, a pentagonal prism 1301, or a hexagonal prism 1302 in FIG. 13A. As a method for generating a route, for example, a case is considered in which the surfaces of the rectangular parallelepiped 1300 are specified in the order of arrows 1303, 1304, and 1305. The center of the rectangular parallelepiped 1300 roughly coincides with the centers of a plurality of 2.5D models. A width and a height of the rectangular parallelepiped 1300 are within a range where the plurality of 2.5D models falls within, and the width and height may be automatically adjusted so that the 2.5D models are located at approximately the same distance from the surface.

The position and orientation of the first viewpoint (hereinbelow, referred to as the starting point) of the route is determined to be on the center of the surface indicated by the arrow 1303 and to face in a direction of the arrow 1303. However, the position of the viewpoint is set so that the plurality of 2.5D models arranged inside the rectangular parallelepiped 1300 is captured in an image. A distance from the surface to the viewpoint may be a fixed value or may be arbitrarily specified by a user. At this time, the user may be able to specify the distance from the surface to the viewpoint by adjusting a length of the arrow 1303. In this way, the user determines the position and orientation of the starting point. In FIG. 13B, a starting point 1310 is indicated. The orientation of the starting point 1310 is set to face a direction of the 2.5D model 400.

Next, a midpoint and an end point of the route are determined. On the second surface specified by the arrow 1304, the position and orientation of the viewpoint at the midpoint are determined in the same manner that the position and orientation of the starting point are determined. The same applies to the arrow 1305. Here, since the arrow 1305 specifies the last surface, the position and orientation of the viewpoint determined by the arrow 1305 becomes those of the end point. If the number of the specified surfaces is two or less, there is no midpoint, and if the number is four or more, there is a plurality of midpoints. In FIG. 13B, a midpoint 1311 and an end point 1312 are indicated.

A route is generated based on information about the starting point, the midpoint, and the end point acquired so far. An existing method may be used to generate the route, for example, a route may be generated using a method for filling a gap between each point at regular intervals using linear interpolation, or a smooth route may be generated using a spline function or the like.

The route may be generated on a spherical surface centered on the center of the rectangular parallelepiped 1300 so that the distance from the center of the rectangular parallelepiped 1300 to each viewpoint is constant. A dashed line 1313 is a route that connects the starting point 1310, the midpoint 1311, and the end point 1312 at equal intervals on the spherical surface. The orientation of each viewpoint is defined to face the center of the rectangular parallelepiped 1300.

The method for generating a route is describe above. Using the 3D primitive enables a user to intuitively generate the route. At this time, each surface of the 3D primitive may correspond to the imaging direction of the 2.5D model. The starting point, the midpoint, and the end point are the imaging direction of the 2.5D model, so that the viewpoint at which a good-looking image can be generated can be included in the route. At this time, the control unit 11 may present an appropriate 3D primitive to a user as a candidate based on the positions and orientations of the plurality of 2.5D models and the imaging directions thereof or may set the appropriate 3D primitive as a default 3D primitive from the beginning. For example, according to the present exemplary embodiment, the 2.5D models are acquired from four directions at approximately equal intervals in the front, back, left and right directions, so that a 3D primitive such as a cube or a rectangular parallelepiped may be set in advance. Accordingly, a user can eliminate time and effort to select a 3D primitive. The surface on which no corresponding 2.5D model exists may be made unselectable. Accordingly, the viewpoint at which a bad-looking image is generated is less likely to be included in the route. Further, at this time, an image may be stored only in a case where the relationship between the viewpoint and the 2.5D model satisfies expression (1) as in the first exemplary embodiment. Accordingly, the viewpoint at which a bad-looking image is generated is less likely to be included in the route.

According to the present exemplary embodiment, a method for acquiring the position and orientation of the 2.5D model is not particularly specified, but a user may input the position and orientation of the 2.5D model using the 3D primitive. At this time, a specifying method can be executed in the same way as the method for specifying the position and orientation of the viewpoint. For example, in a case where a user understands that the 2.5D models are acquired from four directions at approximately equal intervals in the front, back, left and right directions as according to the present exemplary embodiment, the user specifies a cube as the 3D primitive and the 2.5D model corresponding to each surface. Here, top and bottom surfaces that do not include corresponding 2.5D models are not specified. Using the 3D primitive enables a user to intuitively specify the position and orientation of the 2.5D model.

Also, the position and orientation of the 2.5D model may be acquired using a measuring device that acquires a position and an orientation, such as an inertial measurement unit (IMU) or a Global Positioning System (GPS), at the time of acquiring the 2.5D model. Accordingly, the position and orientation of the 2.5D model can be automatically acquired, resulting in reducing a burden on a user. A similar effect can be achieved in a case where the positions and orientations of a plurality of 2.5D models are acquired based on the plurality of acquired 2.5D models and data such as images used to generate the models.

This method does not require the measurement device such as IMU or GPS. A self position estimation method for capturing a large number of images of an object and estimating imaging positions of the images is known as an existing method, and this method may be used to estimate the position and orientation of the 2.5D model.

A third exemplary embodiment described below is an example of an apparatus that executes a 2.5D model processing method by a computer. According to the present exemplary embodiment, a use case in which an object is viewed by appropriately displaying images from arbitrary viewpoints that are acquired in advance using 2.5D models of a head of a person captured from a plurality of directions is described. In other words, according to the present exemplary embodiment, a 2.5D model refers to a plurality of images that can be acquired from a 3D model. A plurality of images may be generated based on a video acquired using the 2.5D model. Descriptions of configurations and processing similar to those according to the first exemplary embodiment are omitted. Some embodiments can be executed on a desktop computer, a laptop computer, a portable computer, and the like.

The 2.5D model processing method according to the present exemplary embodiment is described below, but a configuration of a computer that executes the present processing method is similar to that according to the first exemplary embodiment, so that the description thereof is omitted.

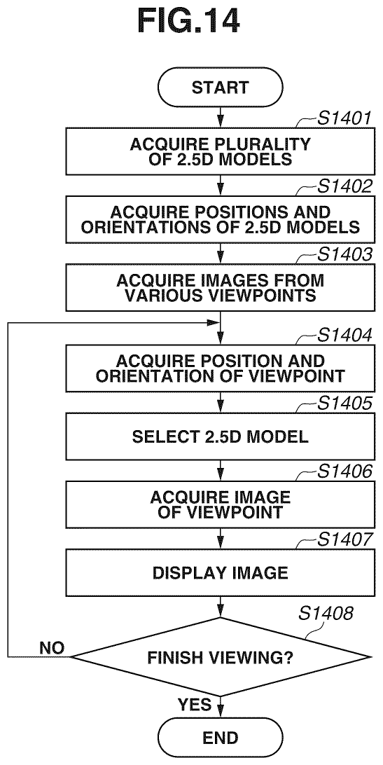

The 2.5D model processing method executed by the computer according to the present exemplary embodiment is specifically described with reference to a flowchart in FIG. 14. However, steps S1401 and S1402 are similar to those according to the first exemplary embodiment, so that the descriptions thereof are omitted.

In step S1403, the control unit 11 acquires images from various positions and orientations of the viewpoints for each of the plurality of 2.5D models and stores the images and information about the positions and orientations of the viewpoints at those times in the storage unit 13. The information about the position and orientation of the viewpoint refers to the position and orientation of the viewpoint itself or information from which the information can be can estimated by calculation. Information from which the information can be can estimated is, for example, the position and orientation of the viewpoint in the coordinate system defined for each 2.5D model. Since relative positions and orientations of the plurality of 2.5D models are known, even though the coordinate system defined for each 2.5D model is used, it is possible to convert the position and orientation of the viewpoint into those in a space in a common coordinate system.

Processing in steps S1404 and S1405 is similar to those according to the first exemplary embodiment, so that the description thereof is omitted.

In step S1406, the control unit 11 acquires an image acquired at the position and orientation closest to the current position and orientation of the viewpoint from among the images acquired in step S1403 for the selected 2.5D model. Comparison of the position and orientation is performed using an existing method such as a nearest neighbor algorithm.

Processing in steps S1407 and S1408 is similar to those according to the first exemplary embodiment, so that the description thereof is omitted.

The method for viewing a 2.5D model by a user controlling the position and orientation of the viewpoint and switching an image to be displayed in a case where there is an image group acquired using each 2.5D model of a head is described above. Since the displayed 2.5D model is switched corresponding to the position and orientation of the viewpoint, it is possible to eliminate time and effort to open the plurality of 2.5D models one by one. Further, an appropriate 2.5D model is selected according the viewpoint, and an image, which is generated using the selected 2.5D model in advance, is displayed, so that incomplete overlap is not generated, and visibility of the object can be maintained. Since the image stored in advance is viewed, the image can be viewed even on a computer that has the difficulty of generating an image.

According to the present exemplary embodiment, a method for storing the image and information about the position and orientation of the viewpoint is not specified, but information about the position and orientation may be stored in meta information of the image, such as an exchangeable image file format (Exif) and a file name. Since the information about the position and orientation is stored in association with the image and the file, information management becomes easier.

Some embodiments of the present disclosure further include the following: First, a program code is read from a storage medium and written into a memory provided in a function expansion board inserted into a computer or a function expansion unit connected to the computer. Then, a CPU or the like provided on the function expansion board or the function expansion unit performs a part or all of actual processing based on an instruction of the program code.

Embodiments of the present disclosure can reduce time and effort to view a plurality of 2.5D models while maintaining visibility of an object.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-171954, which was filed on Oct. 3, 2023 and which is hereby incorporated by reference herein in its entirety.

What is claimed is:

1. An information processing apparatus comprising:
one or more memories storing instructions; and
one or more processors that are in communication with the one or more memories and that, when executing the instructions, cooperate with the one or more memories to:
acquire a plurality of three-dimensional (3D) models each corresponding to a first object and viewing the first object from different viewpoint positions;
specify a position and an orientation of a viewpoint for viewing a 3D model;
select at least one 3D model from among the plurality of 3D models based on the position and orientation of the viewpoint; and
generate an image of the at least one 3D model viewed from the position and orientation of the viewpoint.

2. The information processing apparatus according to claim 1, further comprising a display configured to display the image.

3. The information processing apparatus according to claim 1, wherein the position and orientation of the viewpoint are acquired based on a user input.

4. The information processing apparatus according to claim 1, wherein, when executing the instructions, the one or more processors further cooperate with the one or more memories to generate a moving image based on a plurality of images of the at least one 3D model generated based on positions and orientations of a plurality of viewpoints.

5. The information processing apparatus according to claim 1, wherein the at least one 3D model is selected based on information about the position and orientation of the viewpoint and positions and orientations corresponding to the plurality of 3D models.

6. The information processing apparatus according to claim 5, wherein, of the plurality of 3D models, the at least one 3D model has a smallest cosine between a direction of the position and orientation of the viewpoint and a direction of the corresponding position and orientation.

7. The information processing apparatus according to claim 1, wherein the at least one 3D model is selected from among the plurality of 3D models further based on reliability of shapes of the plurality of 3D models.

8. The information processing apparatus according to claim 5, wherein, when executing the instructions, the one or more processors further cooperate with the one or more memories to receive a user selection of a surface from a 3D primitive that includes a surface corresponding to any one of the plurality of 3D models, and select the position and orientation of the viewpoint and the 3D model.

9. The information processing apparatus according to claim 1, wherein, when executing the instructions, the one or more processors further cooperate with the one or more memories to, in a case where a plurality of the images is generated based on positions and orientations of a plurality of viewpoints, generate first and second images so that a size of at least a part of an object common to the first and second images that are successively generated is the same.

10. The information processing apparatus according to claim 1, wherein, when executing the instructions, the one or more processors further cooperate with the one or more memories to, in a case where the 3D model, of the plurality of 3D models, corresponding to successively generated images changes, determine a position and an orientation of a background model arranged around the 3D model so that a change in the background model is within a predetermined range.

11. The information processing apparatus according to claim 1, wherein, when executing the instructions, the one or more processors further cooperate with the one or more memories to record, in the image, the position and orientation of the viewpoint at the time of generating the image.

12. A method for controlling an information processing apparatus, the method comprising:
acquiring a plurality of 3D models each corresponding to a first object and viewing the first object from different viewpoint positions;
specifying a position and an orientation of a viewpoint for viewing a 3D model;
selecting at least one 3D model from among the plurality of 3D models based on the position and orientation of the viewpoint; and
generating an image of the at least one 3D model viewed from the position and orientation of the viewpoint.

13. A non-transitory computer-readable medium storing computer-executable instructions that, when executed by at least one computer, cause the at least one computer to:
acquire a plurality of 3D models each corresponding to a first object and viewing the first object from different viewpoint positions;
specify a position and an orientation of a viewpoint for viewing a 3D model;
select at least one 3D model from among the plurality of 3D models based on the position and orientation of the viewpoint; and
generating an image of the at least one 3D model viewed from the position and orientation of the viewpoint.
